(19) United States
(12) Patent Application Publication
(10) Pub. No.: US 2022/0021675 A1
(43) Pub. Date: Jan. 20, 2022

(54) METHOD OF USING DHCP HOST NAME TO IDENTIFY A UNIQUE DEVICE IN ABSENSE OF UNIQUE MAC ADDRESS IN ORDER TO APPLY NETWORK FIREWALL OR ACCESS CONTROL RULES

(71) Applicant: Gryphon Online Safety, Inc., San Dieg, CA (US)

(72) Inventor: Arup Bhattacharya, San Diego, CA (US)

(73) Assignee: Gryphon Online Safety, Inc., San Diego, CA (US)

(21) Appl. No.: 17/381,075

(22) Filed: Jul. 20, 2021

Related U.S. Application Data
(60) Provisional application No. 63/053,811, filed on Jul. 20, 2020.

(51) Int. Cl. H04L 29/06

(52) U.S. Cl. CPC H04L 63/10

(57) ABSTRACT

Various embodiments provide an approach to application of access rules for Internet access based on DHCP host names in absence of a unique MAC address. The access rules can be modified by giving due consideration to various parameters associated with the users of the system. The system can be configured and managed by using mobile apps and web interfaces.

### RELATED APPLICATIONS

This application is related to, and claims priority to, the following:
1. Provisional Application Ser. No. 63/053,811, filed Jul. 20, 2020.

The subject matter of the related applications, each in its entirety, is expressly incorporated herein.

### FIELD OF THE INVENTION

The present invention relates to methods, systems and apparatus for enabling controlled browsing of the Internet to provide user safety.

### DESCRIPTION OF RELATED ART

Parents with underage children have a need to control their children's web browsing activities to prevent access to harmful, unsafe or inappropriate websites.

The current methods of implementing network firewalls are heavily dependent on MAC address filtering. A media access control address or MAC address is a unique identifier assigned to a network interface controller (NIC) by the hardware manufacturer for use as a network address in communications within a network segment. This use is common in all IEEE 802 networking technologies, irrespective of physical layer of Ethernet, Wi-Fi, and Bluetooth.

In typical implementations, the MAC address is used to identify a device on the network. In some cases, it may also identify the user of the device so that firewall or access control rules may be applied.

If the MAC address of the device is changed (also, known as MAC spoofing), it would be treated as a new device on the network and a new set of rules may be applied.

This causes problems with application of access control rules. For example, a child may evade parental control rules on a computer or mobile device by changing the device MAC address. Traditional approach to overcome this problem is by blocking any device with new MAC address unless or until it is approved by admin or a parent in the case of a parental control system.

Additional problems arise as operating systems allow users to use private MAC addresses and generate new MAC address every time it reconnects to a router. This makes it almost unmanageable for an admin or parent to manage the access requiring them to allow access every time a computer or mobile device joins the network.

Therefore, there exists a need for a system and method that identifies the networking device by something more than a MAC address, which was considered as unique identifiers of networking devices traditionally.

For the reasons stated above, and for other reasons stated below which will become apparent to those skilled in the art upon reading and understanding the present specification, there is a need in the art for methods, systems and apparatus for enabling controlled browsing of the Internet to provide user safety.

### BRIEF SUMMARY OF THE INVENTION

This Summary is provided to introduce a selection of concepts in a simplified form that are further described below in more detail in the Detailed Description. This Summary is not intended to identify key or essential features of the claimed subject matter.

The present invention generally relates to the method of whitelisting a network client host name (also known as DHCP Host name) to identify a unique device instead of or in combination with a MAC address.

Various embodiments provide methods, systems and, apparatus for controlled access to websites by creating a list of DHCP host names of devices on the network and identifying the devices by use of host names to implement access control rules. In embodiments, information about a user may include the user's profile that may further include user's age, day of the week, and time of the day. A router may be controlled to allow or deny access to the specific website by applying the created specific access rule that controls the access to the specific website for that particular user.

The invention is a method and system that allow the admin and/or a parent to create a list of DHCP host names and configure the router or other filtering hardware to apply same firewall and access control rules for those devices based on its host name irrespective of the device MAC address to avoid circumvention of access control rules by MAC address spoofing.

### BRIEF DESCRIPTION OF DRAWINGS

FIG. 1 illustrates a system in block diagram form for implementing an access control system using DHCP host names for devices instead of their MAC addresses.

FIG. 2 illustrates an alternative embodiment of a system in block diagram form for implementing an access control system using DHCP host names where the DHCP server is a module in the router.

FIG. 3 illustrates in a flow chart form the steps for implementing a method to provide access control using the DHCP host names.

### DETAILED DESCRIPTION

As disclosed herein, current methods of access control by using device MAC address are prone to MAC address spoofing. Parents may want to restrict child's access to certain websites completely and for others they may want to control access only on certain days, or specific times of day, to avoid distractions for their children.

Restrictions imposed by identifying the device by using it's MAC address are prone to MAC address spoofing. A number of new operating systems also provide facilities to users of private MAC address usage and allows for them to setup their own MAC address for their device. Every time the device connects to the network, it may present a completely new MAC address resulting in the device to be recognized as a new device and the already established access rules are of little help.

Almost all network implementations now use the DHCP protocol for allocating the IP addresses automatically to a device connecting on that network.

The Dynamic Host Configuration Protocol (DHCP) provides a framework for passing configuration information to hosts on a TCPIP network. DHCP adds the capability to automatically allocate reusable network addresses and additional configuration options for DHCP clients.

The phrase “DHCP host name” refers to the hostname of the device (client) asking for DHCP address from a DHCP server, such DHCP server may be a standalone server, implemented on a router or another network device.

The DHCP host name can be automatically registered by DHCP server as the client requests the server for a network address or it can be set manually by the user.

Once registered, the router or other networking system may use the DHCP host name to identify a device uniquely, disregarding the MAC address which may or may not be unique anymore and apply the firewall and access control rules accordingly.

The systems and methods may be better understood through the illustrations of certain embodiments provided herein.

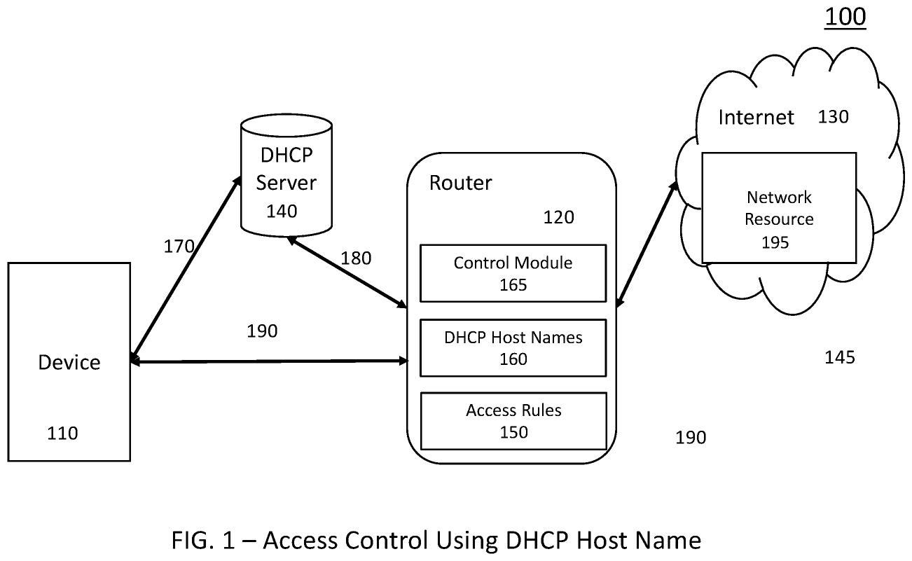

FIG. 1 illustrates in a block diagram form a network system 100 that comprises a network router 120, a DHCP server 140; a device 110 adapted to have a DHCP host name, a network resource 145 available on the Internet 130, a memory adapted to store a list of access control rules 150 available to the router, a memory adapted to store a list of DHCP host names 160 available to the said router, a control module 165 in the router adapted to apply access control rule from the said list of access control rules 150 to a request for access to the said network resource 145 by the said device by using the said device's DHCP host name stored in the said list of DHCP host names 160 to decide access by the said device 110 to the said network resource 145.

Referring to FIG. 1, a network device 110 is part of a network system 100 where the device 110's access to the internet is being controlled through a network router 120. The device 100 may be a computer, mobile device like a smart phone tablet or similar other computing device or even a device with specific narrow utility such as an IP camera, doorbell or any other such smart device with networking capabilities.

FIG. 1 further illustrates a network resource 195 on the Internet 130, such as a website, a social media platform, an image repository, a gaming site or other such resources, that the user of device 110 may want to access. When the device 110 joins the network, the device will send a DHCP discovery request to obtain an IP address using the network channel 170 to the DHCP server 140. The DHCP protocol allows for optional fields for host name and most devices provide a useful name by using predefined convention for that optional field. The DHCP server may collect the DHCP host name of the device and forward that DHCP host name to the router 120, via the communication channel 180, and the router may add that DHCP host name to the list of DHCP host names 160 maintained in the router in a memory block. The router 120, also includes a memory storage area for access rules associated with different users and devices in the list of access rules 150. The router allows access to the Internet 130 and the resources available on the Internet via the communication channel 190.

In certain embodiments, when the device 110 makes a request to access the resource 195 via the channel 190 to the router 120, the router will use the device host name to verify the device being an authorized device by checking the DHCP host list 160. If the device is an authorized device on the network, the router 120 may retrieve the access rules associated with the DHCP host name of the device from the access rules list 150 and provide the information to the control module 165 which applies the access rules associated with the DHCP host name and depending upon whether the access is allowed for that device to the resource being requested may wither allow access or deny access to that resource. The control block may use various parameters in the determination of the access to be allowed which may include parameters such as the age of the user, the time of the day, the day of the week, the particular type of resource being accessed, the cumulative amount of time the device has accessed the Internet, the publicly known safety ranking of the Internet web site or resource being requested for access and other such parameters.

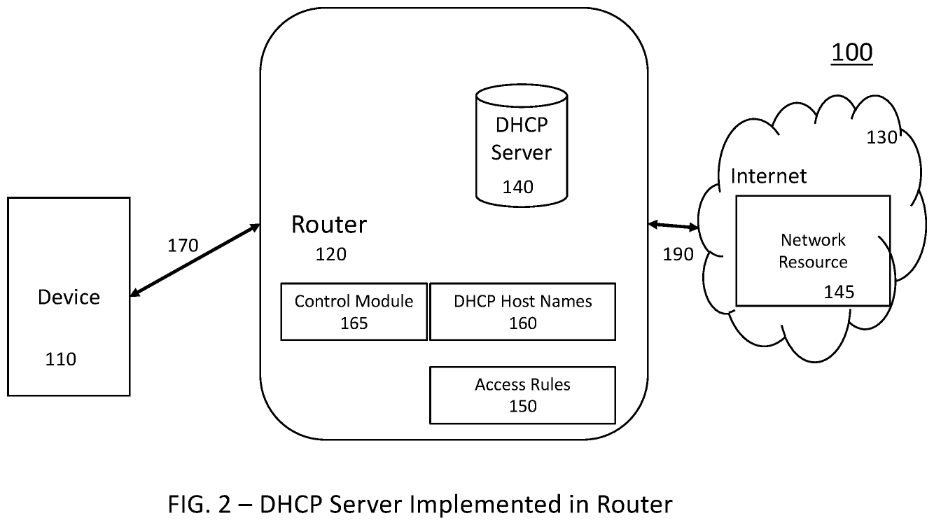

FIG. 2 illustrates another embodiment of a system where the DHCP server 140 is implemented as a module in the Router 120. When the device 110 joins the network, the device will send a DHCP discovery request to the router 120 to obtain an IP address using the network channel 170. The DHCP server module 140 in the router 120 may collect the DHCP host name of the device and may add that DHCP host name to the list of DHCP host names 160 maintained in the router in a memory block. The router 120, also includes a memory storage area for access rules associated with different users and devices in the list of access rules 150. The router allows access to the Internet 130 and the resources available on the Internet via the communication channel 190.

In certain embodiments, when the device 110 makes a request to access the resource 195 via the channel 190 to the router 120, the router will use the device host name to verify the device being an authorized device by checking the DHCP host list 160. If the device is an authorized device on the network, the router 120 may retrieve the access rules associated with the DHCP host name of the device from the access rules list 150 and provide the information to the control module 165 which applies the access rules associated with the DHCP host name and depending upon whether the access is allowed for that device to the resource being requested may wither allow access or deny access to that resource. The control block may use various parameters in the determination of the access to be allowed which may include parameters such as the age of the user, the time of the day, the day of the week, the particular type of resource being accessed, the cumulative amount of time the device has accessed the Internet, the publicly known safety ranking of the Internet web site or resource being requested for access and other such parameters.

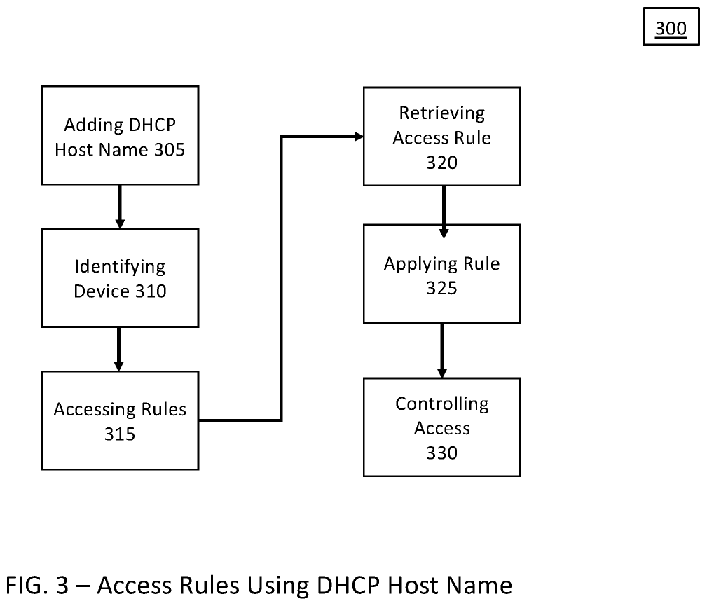

In addition to FIG. 1, referring to FIG. 3, which illustrates the steps involved in the method 300 to control access by using the DHCP host name of the device in a flowchart format. When the device 110 joins the network, the router 120 may implement the step 305 of adding the DHCP host name of the device 110 to the list of DHCP host names 160. On receiving a request from device 100 to access the resource 195, the router may perform the step 310 by identifying the device through its DHCP host name and then perform the step 315 of accessing the rules from the list of access rules 150. The next step of retrieving access rule 320 associated with the DHCP host name is performed by identifying and retrieving the specific access control rule from the list of access control rules with the DHCP host name of the device from the list of DHCP host names associated with that DHCP host name. The control module 165 may use the retrieved access rule and perform the step of applying the rule 320. In certain embodiments, the performance of step 320 may also consider other parameters associated with the DHCP host name such as the age of the user, the time of the day, the day of the week, the particular type of resource being accessed, the cumulative amount of time the user has accessed the Internet, the publicly known safety ranking of the Internet website or resource being requested for access and other such parameters.

The router 120 may perform the step 330 as a result of the application of the access rules to the request by controlling device 110 access to the network resource 195 based on said retrieved access control rule by for the DHCP host name either allowing the device 110 access to the network resource 195 or blocking access to that network resource 195 by the device 110.

In certain embodiments, a user may set the DHCP host name of the device by following the steps provided by an operating system on the device. In yet other embodiments, the user may set the DHCP host name by means of a mobile app used to configure the router or a web interface used for router configuration.

In other embodiments, the DHCP host name for the device may be added to the list of DHCP host names automatically by the DHCP server by obtaining the device's DHCP host name when the device makes a DHCP request to the DHCP server to obtain an IP address.

In certain embodiments, the list of DHCP host names and the list of access control rules may also store specific association of users with specific DHCP host names and specific access control rules.

In yet other embodiments, the application of access rules and access control may be performed by an admin in real time or by configuring such control and access rules with consideration given to user's age, time of day, day of week or such other parameters.

### CONCLUSION

A method and system to apply access rules for safe access of Internet resources by using DHCP host names in absence of unique MAC address is described. Although specific embodiments are illustrated and described herein, it will be appreciated by those of ordinary skill in the art that any arrangement, which is calculated to achieve the same purpose, may be substituted for the specific embodiments shown. This application is intended to cover any adaptations or variations. For example, although described as applicable to minors with emphasis on usage at home in description of certain embodiments, one of ordinary skill in the art will appreciate that the invention is applicable to other environments, such as, businesses and governments, where there may exist a need to provide controlled online access and/or a need to limit the access to certain sites.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments.

We claim:

1. A method comprising:
adding to a list of DHCP host names a DHCP host name of a device on a network requesting access to a network resource;
identifying the said device requesting access to the network resource by means of the DHCP host name of the device;
accessing a list of access control rules;
retrieving an access control rule from said list of access control rules with the said DHCP host name of the said device from the said list of DHCP host names;
controlling device access to the network resource based on said retrieved access control rule for the DHCP host name.

2. The method of claim 1, wherein the step of adding to a list of DHCP host names further comprises the said DHCP host name of the said device set by a user by following the steps provided by an operating system on the device.

3. The method of claim 1, wherein the step of adding to a list of DHCP host names receives the said DHCP host name from a user through a selected one of a mobile app and a web interface.

4. The method of claim 1, wherein the step of adding to the list of DHCP host names receives the said DHCP host name for the said device from a DHCP server when the said device makes a DHCP request to the said DHCP server to obtain an IP address.

5. The method of claim 1, further comprising a step of associating a user to the said device requesting access to the said network resource and also associating the said user to the said list of access control rules.

6. The method of claim 4, wherein the DHCP server is implemented as a module within a router.

7. The method of claim 5, where an access control rule in the said list of access control rules is controlled by an admin based on the user's age, a time of day, and a day of week.

8. A network system comprising:
a router;
a DHCP server;
a device adapted to have a DHCP host name;
a network resource;
a memory adapted to store a list of access control rules connected to the said router;
a memory adapted to store a list of DHCP host names connected to the said router;
a control module in the router adapted to apply access control rule from the said list of access control rules to a request for access to the said network resource by the said device by using the said device's DHCP host name stored in the said list of DHCP host names to decide access by the said device to the said network resource.
